(19) United States
(12) Patent Application Publication
(10) Pub. No.: US 2016/0318609 A1
(43) Pub. Date: Nov. 3, 2016

(54) SYSTEM AND METHOD FOR FLYING TRUCKS

(71) Applicant: Other Lab, LLC, San Francisco, CA (US)

(72) Inventors: Peter Sturt Lynn, Oakland, CA (US); Becker van Niekerk, Zwavelpoort (ZA); Saul Thomas Griffith, San Francisco, CA (US)

(21) Appl. No.: 15/144,708

(22) Filed: May 2, 2016

Related U.S. Application Data
(60) Provisional application No. 62/155,771, filed on May 1, 2015.
(60) Provisional application No. 62/317,337, filed on Apr. 1, 2016.

(51) Int. Cl. B64D 9/00; B64C 29/00; B64C 3/56; B64C 39/10; B64C 39/06; B64C 3/16; B64C 39/02; B64D 1/22

(52) U.S. Cl. CPC B64D 9/00; B64C 39/024; B64C 29/00; B64D 1/22; B64C 39/10; B64C 39/062; B64C 3/16; B64C 3/56; B64C 2201/128; B64C 2201/141; B64C 2201/066; B64C 2039/105; B64C 2201/104; B64C 2201/108; B64D 2211/00

(57) ABSTRACT

A tethered wing comprising an aerodynamic wing body defining external and internal faces and a plurality of rotors disposed on the wing body. The tether wing can further include a tether configured to extend and retract. The tethered wing can be configured to perform a payload pickup maneuver that includes coupling the tether to a payload with the tether in an extended configuration, taking off in a vertical flight configuration proximate to the tethered payload, transitioning to a horizontal flight configuration over the tethered payload and circling and ascending over the tethered payload to lift the tethered payload into the air via the tether.

### CROSS-REFERENCE TO RELATED APPLICATIONS

This application is a non-provisional of and claims the benefit of U.S. Provisional Application No. 62/155,771, filed May 1, 2015, which application is hereby incorporated herein by reference in its entirety and for all purposes.

This application is also a non-provisional of and claims the benefit of U.S. Provisional Application No. 62/317,337, filed Apr. 1, 2016, which application is hereby incorporated herein by reference in its entirety and for all purposes.

### BACKGROUND

Numerous vehicles are configured for aerial flight but are less than ideal transporting cargo or human passengers. For example, helicopters and multi-copters are capable of vertical takeoff and landing, but have poor range, speed, endurance, and efficiency. Fixed wing aircraft can have good range, speed, endurance and efficiency, but require long runways and high speeds to take off and land. Accordingly, a need exists in the art for aerial transport vehicles that can takeoff from a small area and also have good range, speed, endurance and efficiency.

### BRIEF DESCRIPTION OF THE DRAWINGS

FIG. 1 is an exemplary perspective drawing illustrating an embodiment of an arched tethered wing carrying a shipping container.

FIG. 2 is an exemplary perspective drawing illustrating an embodiment of an elliptical tethered wing carrying a shipping container via an extendible and retractable tether.

FIG. 3 is an exemplary perspective drawing illustrating an embodiment of an elliptical tethered wing carrying a passenger vehicle via an extendible and retractable tether.

FIG. 4 illustrates one example implementation of circular lifting of a payload that is coupled to a tethered wing via a tether.

FIG. 5 is a block diagram of one example method of lifting a payload that comprises circling.

FIG. 6 is a block diagram of one example method of descending a payload that comprises circling.

FIG. 7 illustrates an example of a system wherein a tethered wing provides areal transport from a pickup location to a delivery destination.

FIG. 8a illustrates a system where the tethered wing can pick up a payload, travel to a ground-based charging station to recharge, and continue on to a delivery location to deliver the payload.

FIG. 8b illustrates a system where the tethered wing can pick up a payload, travel to an aerial charging station to recharge, and continue on to the delivery location to deliver the payload.

FIG. 9a illustrates a system where a first tethered wing can pick up a payload at a pickup location and the payload can be moved to a second tethered wing while in route to a delivery location.

FIG. 9b illustrates the system of FIG. 9a wherein the transferred payload can be flown to the delivery location by the second tethered wing.

FIG. 10a illustrates an example embodiment of a canonical tethered wing configuration where four rotors are mounted around a ring-wing body that defines a ring with an airfoil profile.

FIG. 10b illustrates an example embodiment of a tethered wing with six integrated ducted fan rotors.

FIG. 11a shows an example embodiment of an elliptical tethered wing where the span of the ring is greater than the height, as per the major and minor axis of an ellipse.

FIG. 11b shows an example embodiment of a tethered wing with a distorted ring-wing body where one side of the ring-wing body comprises increased chord and thickness that can accommodate a payload in some implementations.

FIG. 12a shows an example embodiment of a tethered wing comprising a polygon of straight wing sections.

FIG. 12b shows an example embodiment of a polygon tethered wing where the span is greater than the height as per an ellipse.

FIG. 13 shows an example embodiment of a polygon tethered wing in a folded or packed configuration wherein sections of the wing body have been disengaged from a ring configuration at respective joints and stacked.

FIGS. 14a and 14b show an example embodiment of an elliptical ring-wing body with differently sized and positioned rotors and an integrated fuselage.

FIG. 15a shows another embodiment of a tethered wing coupled to a payload via a tether.

FIG. 15b shows an example embodiment of a tethered wing which is directly tethered to an anchor via a tether, wherein the tethered wing circles above the anchor.

FIG. 16a illustrates a tethered wing having a ring wing body in a horizontal flight configuration relative to a payload, wherein the ring wing body is coupled directly to the payload.

FIG. 16b illustrates the tethered wing of FIG. 6a wherein the ring wing body 110 is in a vertical flight configuration relative to a payload.

FIG. 17 illustrates the tethered wing of FIGS. 16a and 16b with a tether being in an extended configuration.

FIG. 18 illustrates a tethered wing comprising a wing body of a teardrop shape with a rotor body bifurcating the orifice of the wing body.

FIG. 19a illustrates an example of a quadcopter of various embodiments.

FIG. 19b illustrates an example of a hexcopter of various embodiments.

FIG. 20 illustrates an embodiment of a rocket-like system that comprises a plurality of rotors arranged around an aerodynamic body that includes a nose cone and a tail.

FIG. 21a illustrates a front view of an example embodiment of a tethered wing comprising a bean-shaped wing body.

FIG. 21b illustrates a perspective view of the tethered wing comprising a bean-shaped wing body of FIG. 21a.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

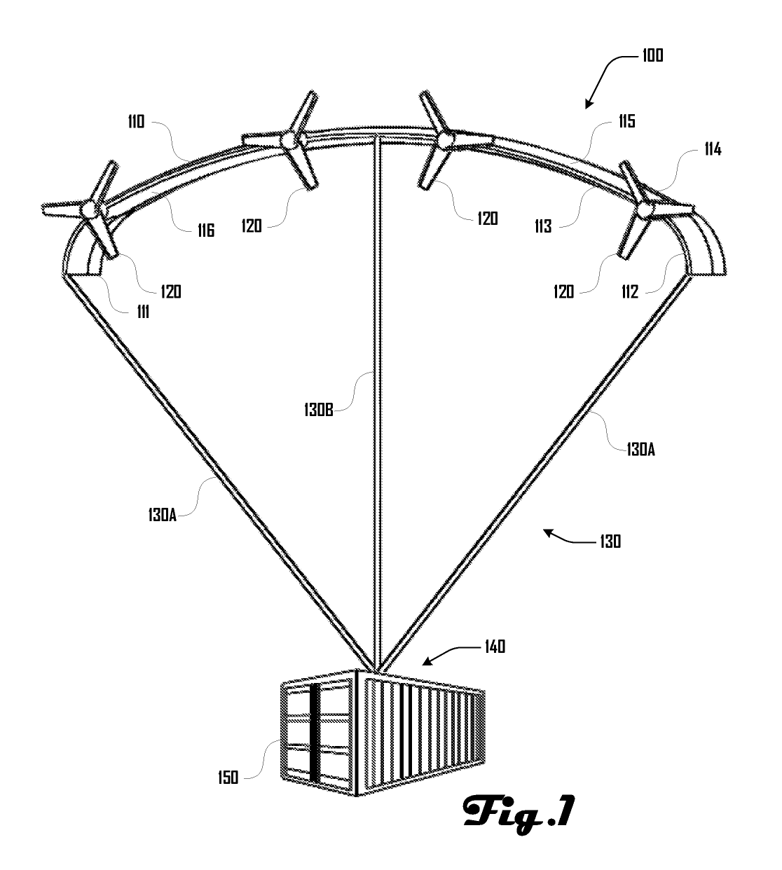

Turning to FIG. 1, a tethered wing 100 is shown as comprising a wing body 110 with a plurality of rotors 120 coupled between a first and second end 111, 112 of the wing body 110 along a front edge 113 of the wing body 110. For example, as illustrated in FIG. 1, the wing body 110 can be curved between the first and second ends 111, 112 and define a suitable wing contour on external and internal faces 115, 116 between the front and rear edges 113, 114.

In various embodiments, the rotors 120 can be configured to rotate in a plane that is substantially perpendicular to the faces 115, 116 of the wing body 110. Additionally, although the example of FIG. 1 comprises four rotors 120, various embodiments can include any suitable number of rotors 120, including 1, 2, 3, 4, 5, 6, 7, 8, 9, 10, 12, 14, 16, 18, 20, 30, 40, 50, 100, 200, 500 or the like. Furthermore, although rotors 120 are shown being disposed in a configuration having an axis of reflective symmetry between rotors 120, in some embodiments, an axis of reflective symmetry can be at a rotor 120, or rotors 120 may not be disposed with symmetry in further embodiments.

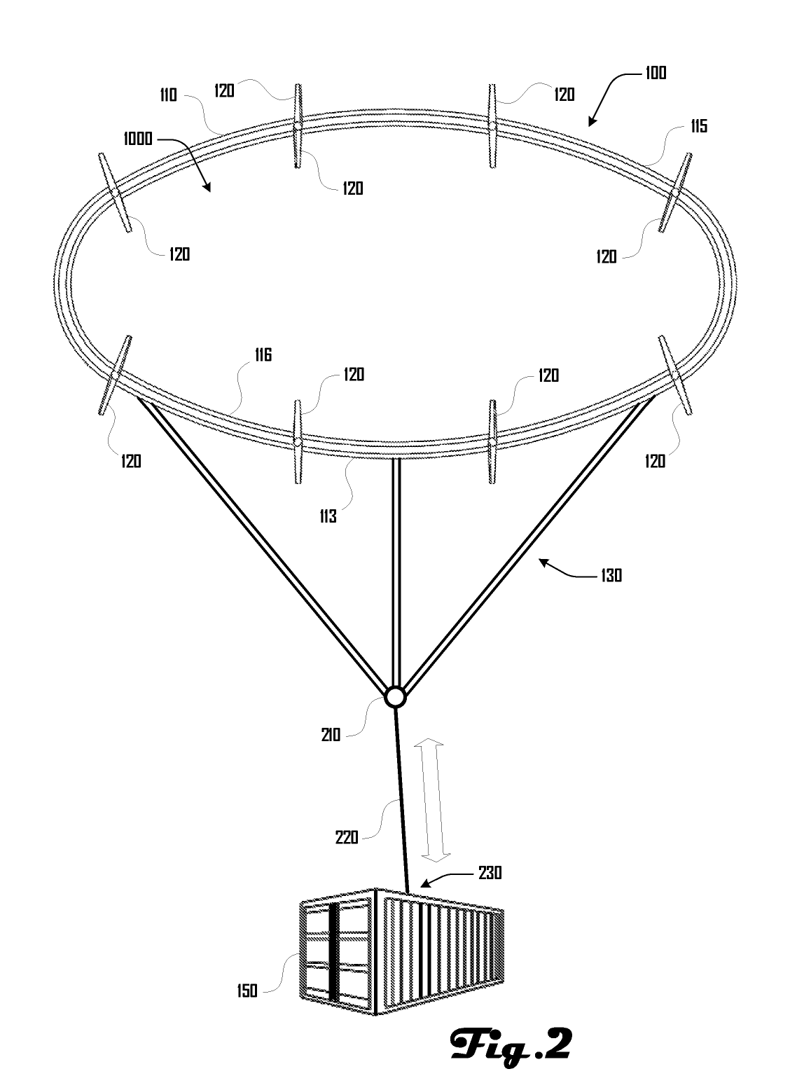

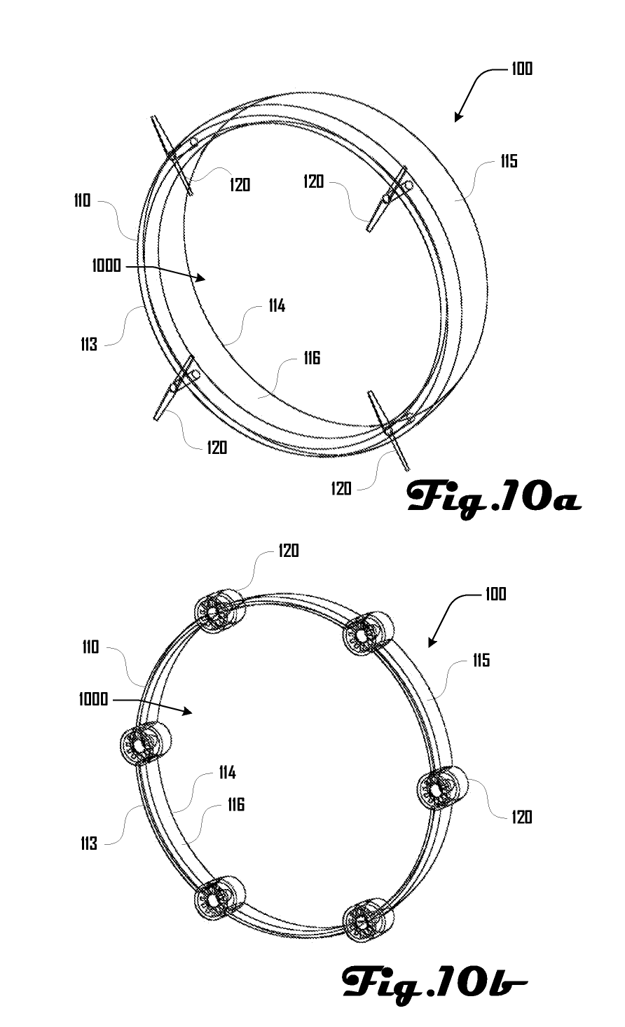

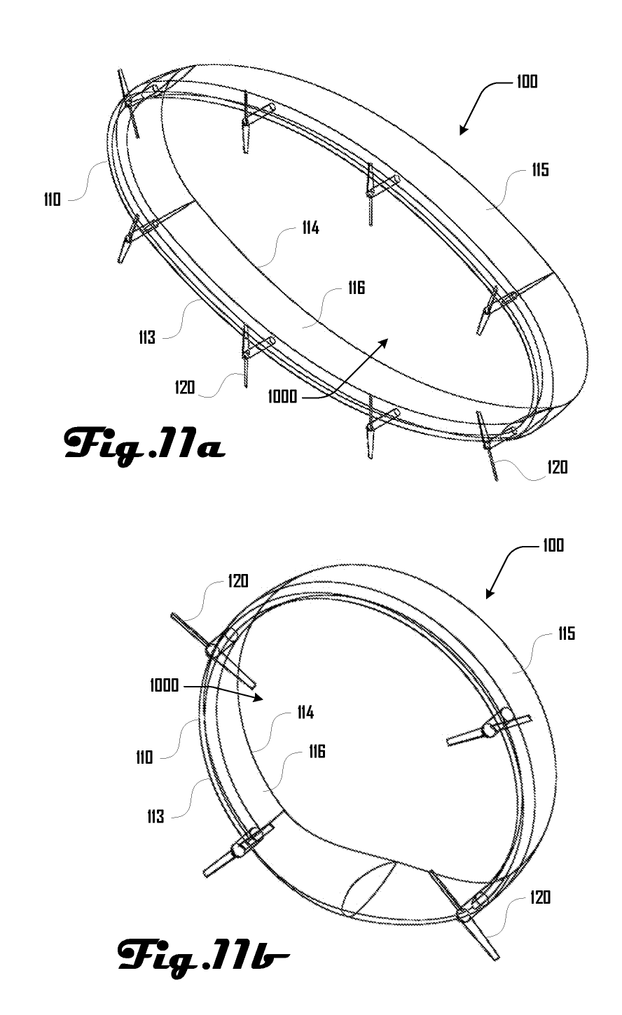

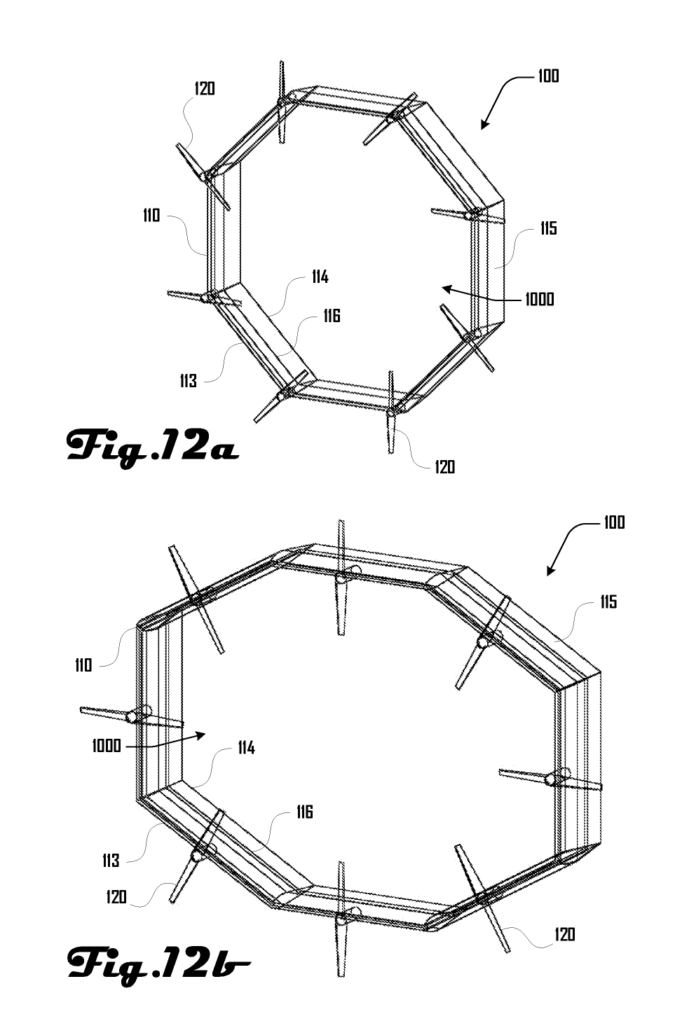

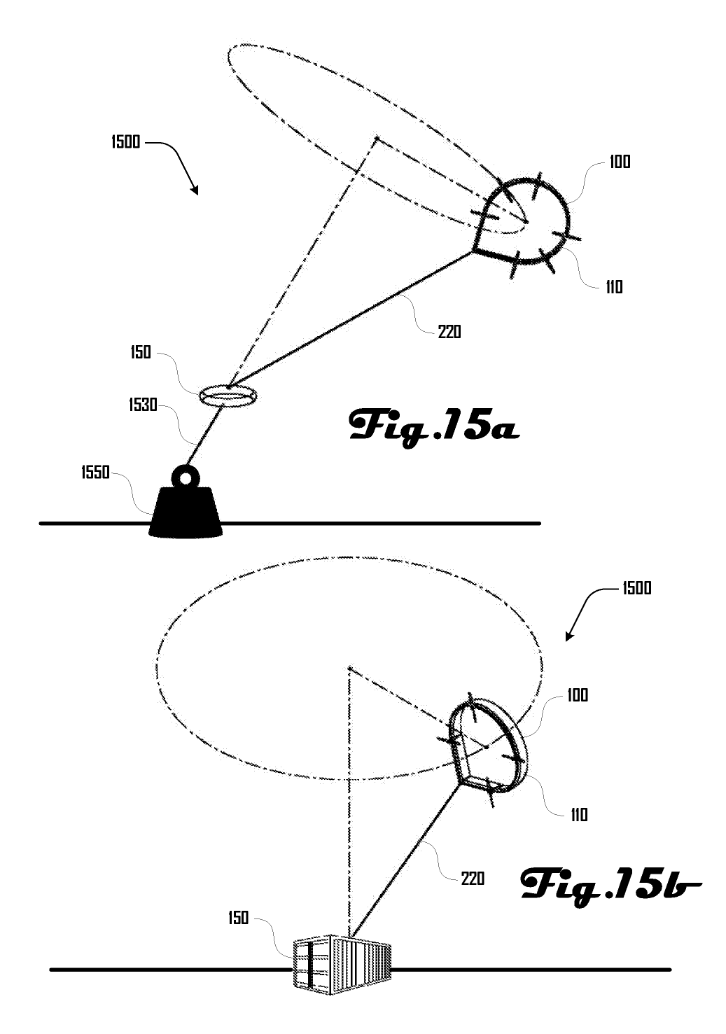

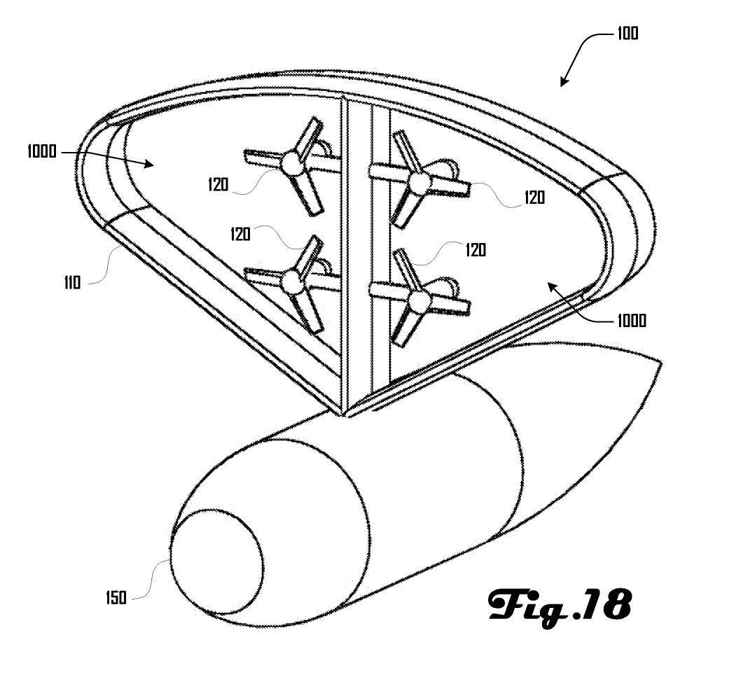

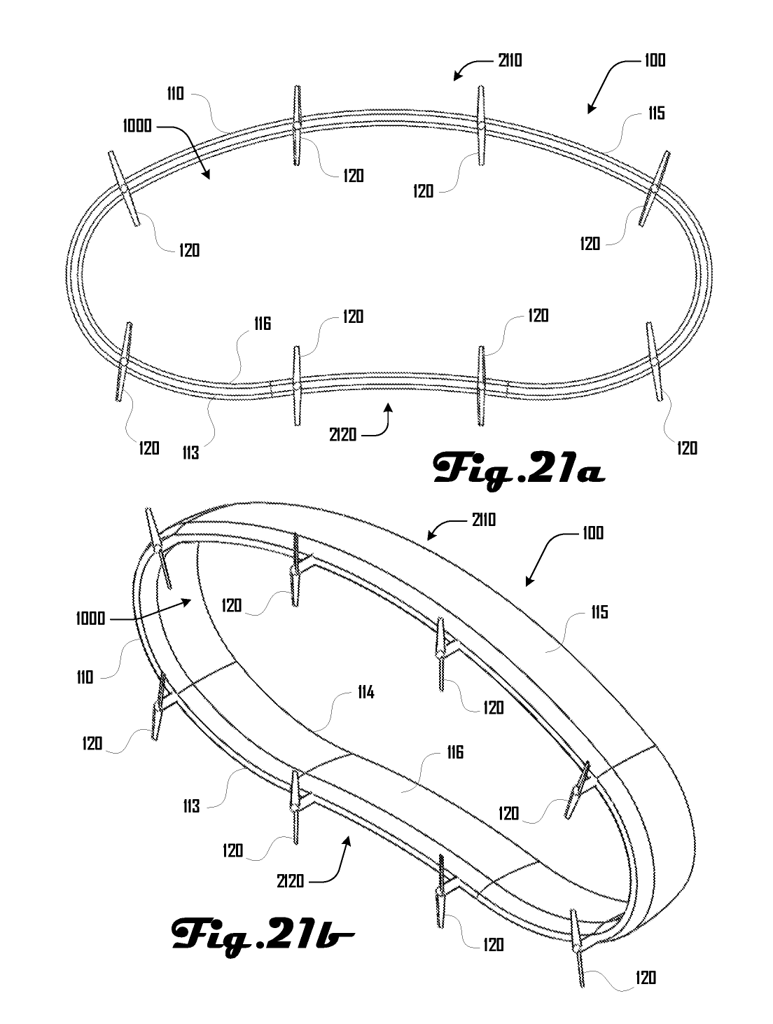

Additionally, although FIG. 1 illustrates an example embodiment of a curved wing body 110 having first and second ends 111, 112, further embodiments can comprise a wing body 110 of various other suitable forms, including a circle (e.g., FIGS. 10a and 10b), an oval (e.g., FIGS. 2, 3, 11a, 14a and 14b), an arc polygon, (e.g., FIG. 11b), a regular or irregular polygon (e.g., FIGS. 12a and 12b), a teardrop (e.g., FIGS. 15a, 15b and 18), a bean shape (e.g., FIGS. 21a and 21b) or the like.

Returning to FIG. 1, the tethered wing 100 can be coupled to a payload via a plurality of lines 130 that extend from the wing body 110 and couple with the payload 150 at a connection point 140. In the example of FIG. 1, a pair of end lines 130A extend from the front edge 113 of respective ends 111, 112 of the wing body 110 and a central line 130B extends from a central portion of the front edge 113 of the wing body 100. However, in further embodiments, any suitable configuration of lines 130 can be provided with one or more lines 130 extending from the wing body 110 at various suitable locations. For example, in another embodiment, lines 130 can extend from close to the aerodynamic center of the profile of the wing body 110 which is typically at around 25% of chord (i.e., 25% back from the leading edge).

In some embodiments, lines 130 can be directly coupled with a payload 150 as illustrated in FIG. 1, but in further embodiments as illustrated in FIG. 2 for example, lines 130 can be coupled to a winch 210 which is configured to extend and retract a tether 220 that is coupled to a payload 150 at a coupling end 230 of the tether 220. As discussed in more detail herein, the tether 220 can be extended and/or retracted during lifting of a payload 150 into the air and during delivery of the payload 150 to a drop zone. In various embodiments, the tether 220 and/or lines 130 can be faired, which can be desirable for reducing drag. In some embodiments, as discussed herein, the tether 220 and/or lines 130 can comprise or house electrical lines, fuel lines, communication lines, or the like. In one embodiment, the tether 220 and/or lines 130 can comprise carbon fiber and/or gel spun Ultra-High-Molecular-Weight PolyEthylene (UHMWPE) (e.g., Spectra/Dyneema).

In accordance with various preferred embodiments, the tethered wing 100 can be configured for cargo shipping. For example, a tethered wing 100 can be configured to replace or comprise a portion of shipping systems that may comprise tractor-trailer trucks, cargo ships, trains and the like. In other words, various embodiments of the tethered wing 100 can be configured for transport of large and/or heavy cargo over large distances.

Accordingly, as illustrated in the example embodiments of FIGS. 1 and 2, a payload 150 can comprise a shipping container. Such a shipping container payload 150 can include an International Standards Organization (ISO) standard shipping container as defined in various suitable standards years, including year 2016, 2015, 2014 or any suitable year before or after. For example, in various embodiments a shipping container can comprise an ISO 10′ Standard Dry Container, 20′ Standard Dry Container, 40′ Standard Dry Container, 40′ High Cube Dry Container, 45′ High Cube Dry Container, 20′ Refrigerated Container, 40′ Refrigerated Container, 40′ High Cube Refrigerated Container, or the like. In further examples, such an ISO standard shipping container can comprise a shipping container defined by ISO 55.180.10, ISO/TC 104, or the like.

In some embodiments, the payload can include an ISO standard air cargo container as defined in various suitable standards years, including year 2016, 2015, 2014 or any suitable year before or after. For example, such an ISO standard air cargo container can comprise an air cargo container defined by ISO 55.180.30, ISO/TC 20/SC 9, or the like. In further embodiments, a payload 150 can comprise a plurality of suitable shipping containers. In still further embodiments, a payload 150 can comprise any suitable non-standard shipping container. In other embodiments, a payload 150 can comprise a house, building, vehicle, or the like.

In some embodiments, a payload 150 can be configured for areal transport. For example, a payload 150 can comprise an aerodynamic shell, stabilization fin, rotor, wing, flap, aileron, elevator, rudder, nose cone, or other suitable components. In some embodiments, such structures can be passive and non-moving or can be active structures. In other words, the payload 150 can comprise and active thrust stabilizing system configured to control the position and orientation of the payload. For example, in some embodiments such structures can be configured to alter the velocity, flight path, orientation or rotation of the payload 150.

Accordingly, in various embodiments, the tethered wing 100 can comprise a control system configured to control the velocity, flight path, orientation or rotation of the tethered wing 100 and such a control system can also be configured to control the velocity, flight path, orientation or rotation of the payload 150. Such a control system can communicate with suitable structures associated with the payload via wired and/or wireless communication.

In some embodiments, such structures can be integrally coupled with a shipping container. However, in further embodiments, such structures can be removably coupled to a shipping container. For example, in one embodiment, an architecture or housing configured for areal transport can be removably coupled with a standardized shipping container in preparation for areal transport via the tethered wing 100. Such embodiments can be desirable so that standard shipping containers can be used with conventional shipping infrastructure while not being transported via air, and then coupled with such a structure to provide for more controlled and efficient areal transport.

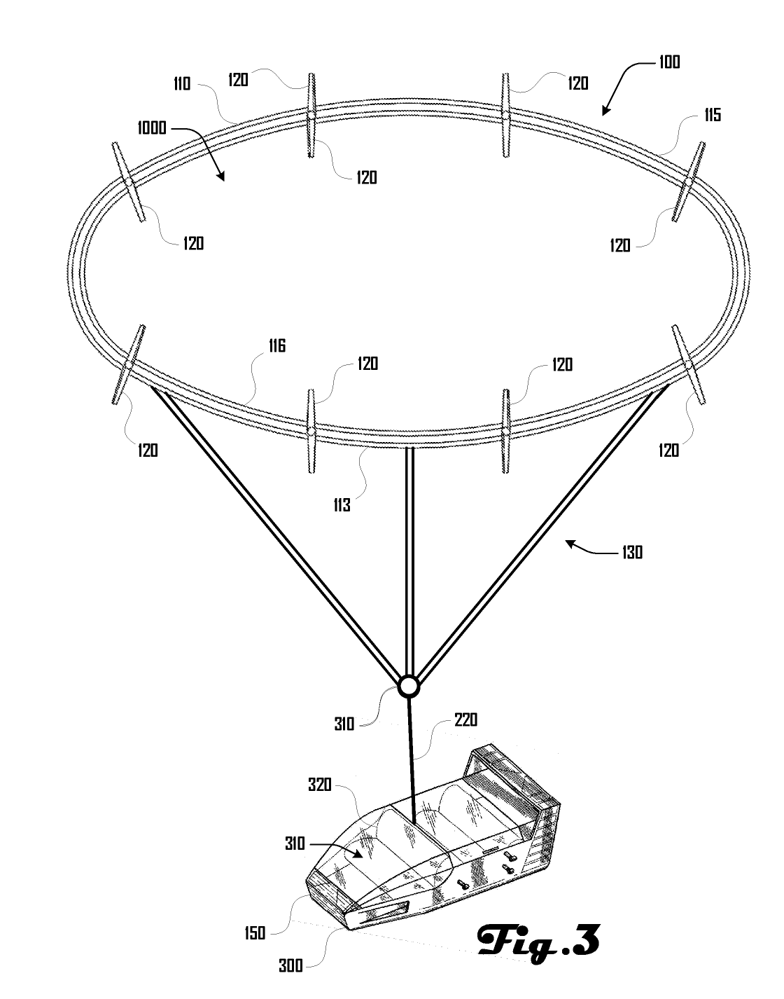

Any suitable cargo can be shipped or transported as part of a payload 150 including, vehicles, building materials, food, clothing, electronic goods, fuel, and the like. Additionally, in further embodiments, human passengers can comprise a payload 150. For example, FIG. 3 illustrates an example embodiment where a payload 150 comprises a passenger vehicle 300. As shown in this example, the passenger vehicle 300 can comprise a cabin 310, that includes seats 320 configured to accommodate human passengers. A passenger vehicle 300 can take on any suitable form in further embodiments and the example of FIG. 3 should not be construed to be limiting on the wide variety of embodiments of a passenger vehicle 300 that are within the scope and spirit of the present invention.

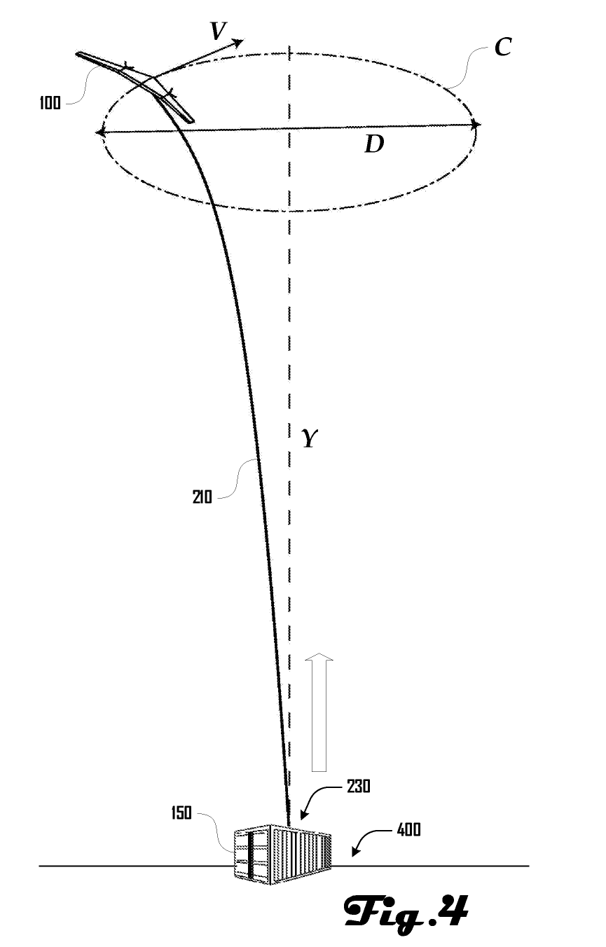

Lifting and landing a payload 150 can be done in various suitable ways. For example, FIG. 4 illustrates one example implementation of lifting a payload 150 that is coupled to a tethered wing 100 via a tether 210. As shown in FIG. 4, a payload 150 can be disposed at a pickup location 400 and the tethered wing 100 can circle over the pickup location 400 about an axis Y that extends through the coupling point 230 between the tether 210 and the payload 150, with axis Y being perpendicular to the pickup location 400. The tethered wing 100 can circle in a circular pattern C having diameter D with the center of the circular pattern C being coincident with axis Y. To lift the payload 150, the tethered wing 100 can increase altitude while maintaining circular flight pattern C, which can lift the payload 150 off the pickup location 400.

In other words, the tethered wing 100 can fly in a substantially horizontal circular flight pattern C and elevate in a corkscrew or spiral to lift the payload 150. Such a lifting configuration can be desirable because it can provide for more efficient lifting of the payload 150 compared to lifting directly along axis Y. In various embodiments, diameter D can be consistent during lifting, can be increasing during lifting, can be decreasing during lifting or can be variable during lifting. Additionally, in various embodiments, where the tether 210 is associated with a winch 210 (e.g., as shown in FIGS. 2 and 3), the length of the operating length of the tether 210 can be increased and/or decreased as desired.

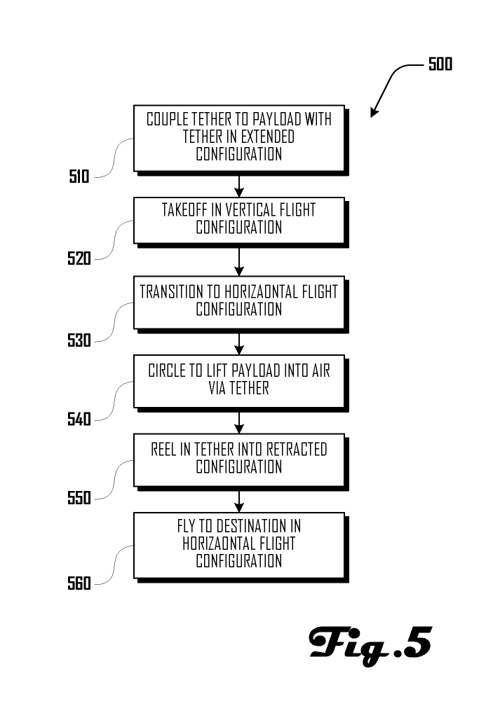

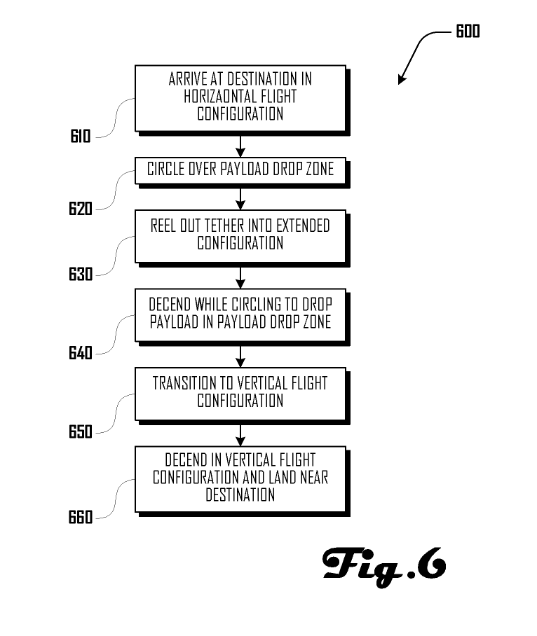

Such a lifting method as illustrated in FIG. 4 can be used for lifting a payload and/or descending a payload 150. For example, FIG. 5 is a block diagram of one example method 500 of lifting a payload 150 that comprises circling and FIG. 6 is a block diagram of an example method 600 of descending a payload 150 that comprises circling. Turning to FIG. 5, the method 500 begins, at 510, where a tether 210 is coupled to a payload 150, with the tether 210 in an extended configuration.

The method 500 continues to 520, where the tethered wing 100 takes off in a vertical flight configuration proximate to a pickup location 400 and transitions to a horizontal flight configuration, at 530. For example, in various embodiments, a tethered wing 100 having a wing body 110 comprising a plurality of rotors 120 can be configured for vertical takeoff and can be configured for movement in a horizontal configuration. In some embodiments, vertical takeoff or vertical flight configuration can include the tethered wing 100 ascending with rotors 120 spinning parallel to a takeoff zone with faces 115, 116 of the wing body 110 being perpendicular to the takeoff zone. In some embodiments, horizontal movement or a horizontal flight configuration can include rotors 120 spinning substantially perpendicular to the ground or a takeoff zone with faces 115, 116 of the wing body 110 being substantially parallel to the ground.

Returning to the method 500, at 540, the tethered wing 100 circles in a horizontal flight configuration to lift the payload 150 into the air via the tether 220. For example, as discussed herein, circling in a horizontal flight configuration (e.g., FIG. 4) can include circling and elevating in a corkscrew or coil pattern to lift a payload from a pickup location.

At 550, the tether 220 is reeled in to a retracted configuration, and at 560, the tethered wing 100 flies to a destination in the horizontal flight configuration. In various embodiments, it can be desirable to have the tether 220 in a longer extended configuration when the tethered wing 100 is taking off. For example, having an extended tether 220 can provide for vertical takeoff of the tethered wing 100 proximate to the payload 150 without the tether 220 becoming taught before a desired altitude and/or a horizontal flight configuration is attained. Additionally, having a long tether 220 can be desirable for lifting the payload 150 via circling as discussed herein. On the other hand, having a retracted or shorted tether 220 can be desirable during flight to a destination and can provide for increased control over the payload 150 during flight, can provide for less drag during flight, and can reduce the profile of the tethered wing 100 and payload 150 traveling together, which can make it less likely that the tethered wing 100 and payload 150 will collide with or become tangled in objects while traveling.

Similar steps can be used to deliver a payload to a drop zone or destination. For example, FIG. 6 illustrates a method 600 for delivering a payload 150, which begins at 610, where the tethered wing 100 arrives at a destination in a horizontal flight configuration, and at 620, circles over the payload drop zone.

At 630, the tether 220 is reeled out into an extended configuration, and at 640, the tethered wing 100 descends while circling in a horizontal flight configuration to drop the payload 150 at the payload drop zone. For example, the tethered wing 100 can circle in a coil or corkscrew flight pattern while descending to drop the payload 150 at the payload drop zone. In other words, just as the tethered wing 100 can ascend in a coil or corkscrew flight pattern to lift a payload, the tethered wing 100 can descend in a coil or corkscrew flight pattern to deliver a payload 150 at a payload drop zone.

Returning to the method 600, the tethered wing 100 transitions to a vertical flight configuration, and at 660, descends in the vertical flight configuration and lands near that destination. In various embodiments, a tethered wing 100 configured for collective and independent vertical takeoff and landing can be desirable because it can provide for takeoff and/or landing in smaller takeoff and landing areas compared to vehicles that land and takeoff in a horizontal flight configuration. Additionally, being capable of transitioning to and from horizontal flight can be desirable for a tethered wing 100 because a horizontal flight configuration can provide for efficient lifting and descending a payload 150 via circling and provide for an efficient configuration for traveling from place to place compared to a horizontal flight configuration.

Transitioning between vertical and horizontal flight configurations can be done in various suitable ways. For example, in various embodiments, the rotors 120 can be disposed in a static configuration on the wing body 110 and transitioning between vertical and horizontal flight configurations can include rotation of the wing body 110 to or from a vertical or horizontal configuration or orientation. Such embodiments can be desirable because they can substantially simplify the operation of the tethered wing 100 and reduce the number of moving parts. Alternatively, in further embodiments, the rotors 120 can be configured to rotate or move and the wing body 110 can maintain the same orientation.

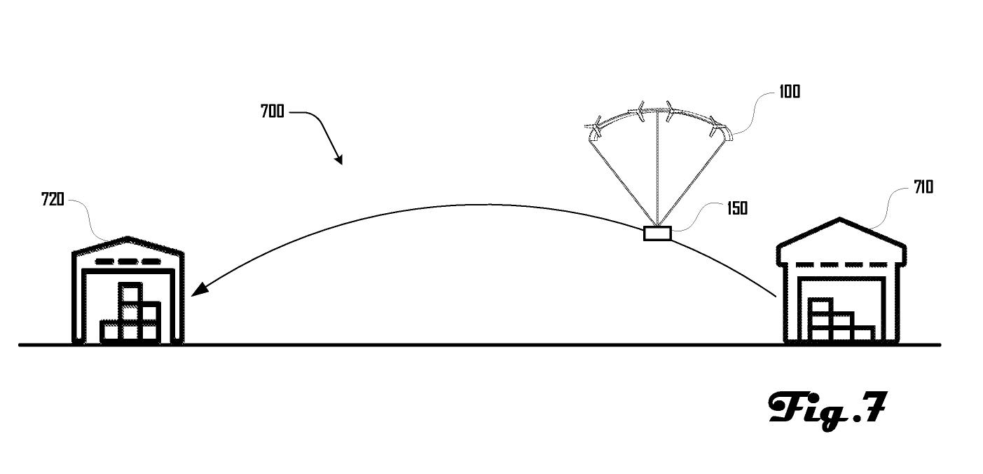

As discussed herein, a tethered wing 100 can be used for areal shipping of various payloads 150 between a pickup location and a destination or drop zone and such shipping can be done in various suitable ways with various suitable systems. For example, FIG. 7 illustrates an example of a system 700 wherein a tethered wing 100 provides areal transport from a pickup location 710 to a delivery destination 720. Although this example illustrates the pickup location 710 and delivery destination 720 comprising a warehouse, in further embodiments any suitable pickup location and delivery location can be part of such system. For example, one or both of the pickup location and delivery location can comprise a commercial building, a factory, an apartment building, a residential home, a warehouse, a ship, a train, a truck, and the like.

In some embodiments, the tethered wing 100 can be configured to deliver payloads 150 to a delivery location without recourse to secondary lifting devices (e.g., lifted from and/or deposited directly to a ship, train, or truck). In further embodiments, transportation vehicles can comprise a delivery location and such transportation vehicles can be in motion or located away from conventional shipping drop-off or pickup locations. For example, payloads 150 can be picked up and/or delivered to ships while at sea without the need for docking at a port and such ships can be stationary or moving at the time of pickup and/or delivery. In a further example, payloads can be picked up or dropped off from a train while the train is away from a station or other conventional delivery or loading location and the train can be stationary or in motion.

Additionally, as discussed in more detail herein, a tethered wing 100 or other aerial vehicle can serve as a pickup and/or drop-off location. For example, a “mothership” aerial vehicle can carry a plurality of payloads, and one or more tethered wing 100 associated with the “mothership” can bring payloads 150 to the “mothership” from pickup locations and/or remove payloads 150 from the “mothership” and deliver these payloads 150 to one or more delivery locations.

In various embodiments, a tethered wing 100 can be powered in various suitable ways including via electrical power and/or a fuel source such as gasoline, liquid natural gas, hydrogen, or the like. In other words, some embodiments of a tethered wing 100 can be powered via hybrid power sources, powered only by a chemical fuel, powered only by electricity, or the like. For embodiments of a tethered wing 100 comprising electrical power, such electrical power can be derived from a battery source, a fuel source, solar energy, laser energy, turbine energy, or the like.

In some embodiments, the range of transportation via a tethered wing 100 can be limited to a range based on an amount of energy that can be stored by the tethered wing 100 and/or payload 150 or by an amount of energy that can be generated by the tethered wing 100 and/or payload 150 during flight (e.g., via solar energy). In other words, a delivery range can be based on a range within which the tethered wing 100 will not run out of energy.

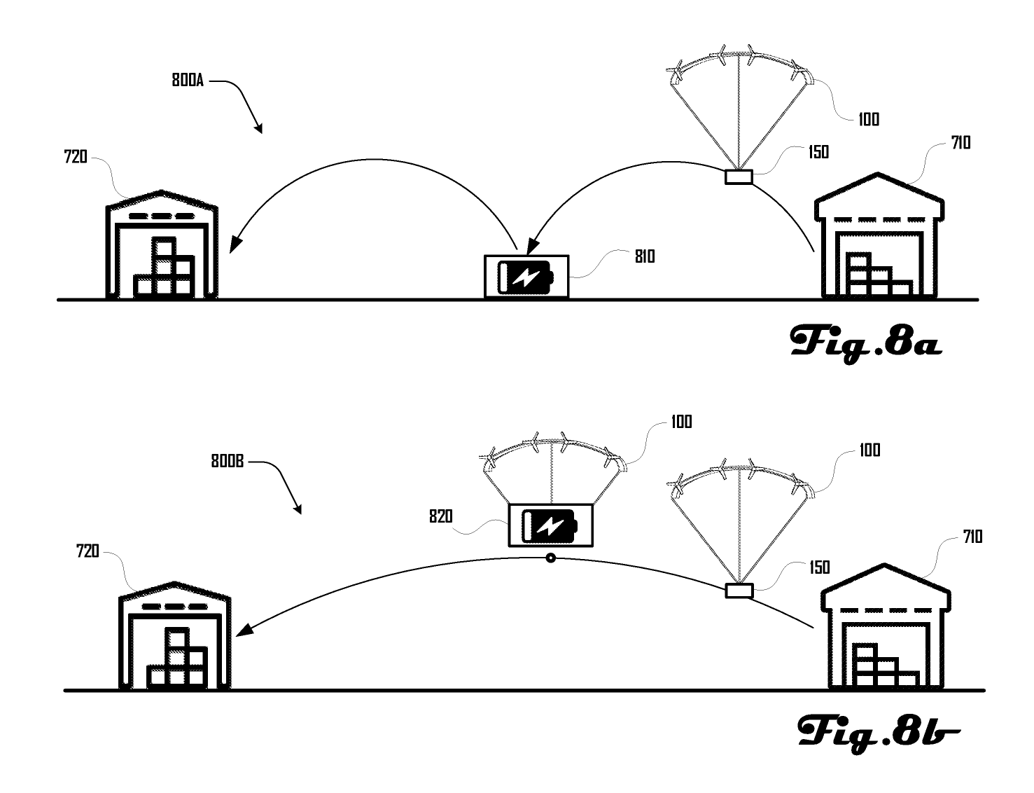

However, in further embodiments, a tethered wing 100 can recharge and/or re-fuel while traveling between a pickup location 710 and delivery destination 720. For example, FIGS. 8a and 8b illustrate example systems 800A, 800B where a tethered wing 100 is configured to recharge via a charging station 810, 820 while traveling between a pickup location 710 and delivery destination 720.

More specifically, FIG. 8a illustrates a system 800A where the tethered wing 100 can pick up a payload 150, travel to a ground-based charging station 810 to recharge, and continue on to the delivery location 720 to deliver the payload 150. In such an embodiment, the tethered wing 100 can be configured to land at or on the ground-based charging station 810 or can be configured to recharge via the ground-based charging station 810 while remaining in the air. For example, the tethered wing 100 can be configured to land vertically on or proximate to a ground-based charging station 810 or can engage with the ground-based charging station 810 while flying via the payload 150, via a charging probe, and the like.

In further examples, the tethered wing 100 can be configured to recharge via an aerial charging station 820 as illustrated in FIG. 8b. The example system 800B of FIG. 8b illustrates the aerial charging station 820 being associated with a tethered wing 100, but in further embodiments any suitable aerial vehicle can be used to carry an aerial charging station 820. In some examples, the aerial charging station 820 can remain in a defined area and wait for a tethered wing 100 or can fly to meet a tethered wing 100 for recharging.

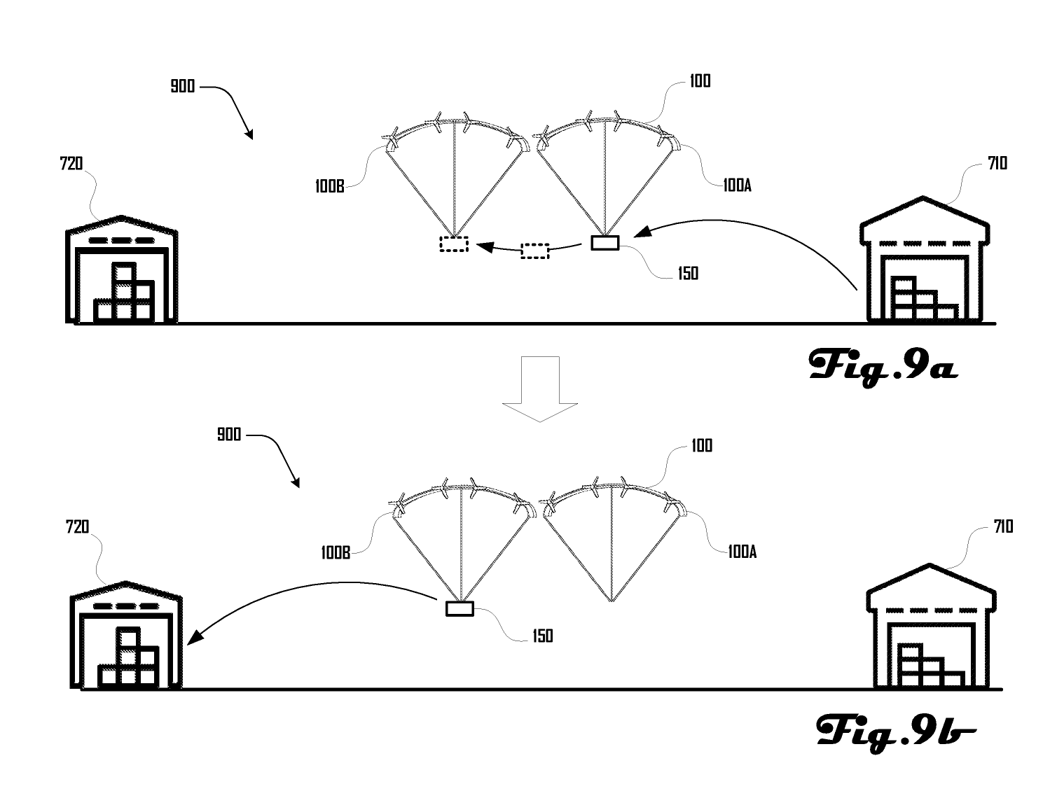

In some embodiments, as illustrated in FIGS. 9a and 9b a first tethered wing 100A can be configured to transfer a payload 150 to a second tethered wing 100B while both tethered wings 100A, 100B are in the air. For example, FIG. 9a illustrates a system where the first tethered wing 100A can pick up a payload 150 at a pickup location 710 and the payload 150 can be moved to a second tethered wing 100B while in route to a delivery location 720. As illustrated in FIG. 9b, the transferred payload 150 can be flown to the delivery location by the second tethered wing 100B.

In some embodiments, a payload 150 can be transferred to the second tethered wing 100B that is empty, which can leave the first tethered wing 100A empty. However, in further embodiments, such transferring or swapping may or may not leave one or both of the tethered wings 100A, 100B empty. In other words, in some examples, a tethered wing 100 can carry a plurality of payloads 150, and swap payloads with one or more other tethered wings 100 that may be empty or may be carrying one or more payload 150.

For example, in some embodiments, a “mothership” tethered wing 100 (or other aerial vehicle) can receive or provide payloads 150 to one or more tethered wings 100. Such embodiments can be desirable because such a “mothership” can be configured to efficiently carry and transport a plurality of payloads 150, whereas tethered wings 100 that pickup and/or drop-off payloads 150 can be configured to efficiently transport fewer payloads 150.

In various embodiments, any of the described functionalities, methods, actions or the like can be performed automatically without human interaction. For example, in one embodiment, the pickup or drop-off methods of FIG. 5 and FIG. 6 can be performed automatically without human interaction or any of the individual steps can be performed automatically without human interaction. In one example, a user can select or identify a payload 150 and a tethered wing 100 can automatically pick up the payload without human interaction. In another example, a user can select a drop zone, and a tethered wing 100 can drop a payload 150 in the drop zone automatically without human interaction. In a further example, a user can select a payload and a drop zone and a tethered wing 100 can automatically pick up the payload 150 and drop the payload in in the drop zone automatically without human interaction. Additionally, while some embodiments provide for a tethered wing 100 operated directly by a human user, various embodiments provide for an autonomous or unmanned tethered wing 100 without a human user.

As discussed herein a tethered wing 100 can take on various suitable morphologies including a plane wing, helicopter wing, bridled wing, arch wing, or the like. Additionally, in further embodiments, a tethered wing 100 can comprise a ring-wing morphology where a wing body 110 defines one or more a ring orifice 1000 as illustrated in FIGS. 2, 3, 10a, 10b, 11a, 11b, 12a, 12b, 14a, 14b, 15a, 15b, 16a, 16b, 17 and 18. A ring-wing can be defined by any suitable shape including a circle (e.g., FIGS. 10a and 10b), an oval (e.g., FIGS. 2, 3, 11a, 14a, 14b, 16a, 16b and 17), an arc polygon, (e.g., FIG. 11b), a regular or irregular polygon (e.g., FIGS. 12a and 12b), a teardrop (e.g., FIGS. 15a, 15b and 18), a bean shape (e.g., FIGS. 21a and 21b) or the like.

More specifically, FIG. 10a illustrates an example embodiment of a canonical tethered wing 100 configuration where four rotors 120 are mounted around a ring-wing body 110 that defines a ring with an airfoil profile. FIG. 10b illustrates an example embodiment of a tethered wing 100 with six integrated ducted fan rotors 120. In some embodiments, ducted fan rotors 120 can be in counter rotating pairs or tilted slightly off axis for yaw control in vertical flight mode.

FIG. 11a shows an example embodiment of an elliptical tethered wing 100 where the span of the ring is greater than the height, as per the major and minor axis of an ellipse. FIG. 11b shows an example embodiment of a tethered wing 100 with a distorted ring-wing body 110 where one side of the ring-wing body 110 has increased chord and thickness that can accommodate a payload in some implementations. The rotors 120 in this non-limiting example are illustrated in a rotationally non-symmetric layout.

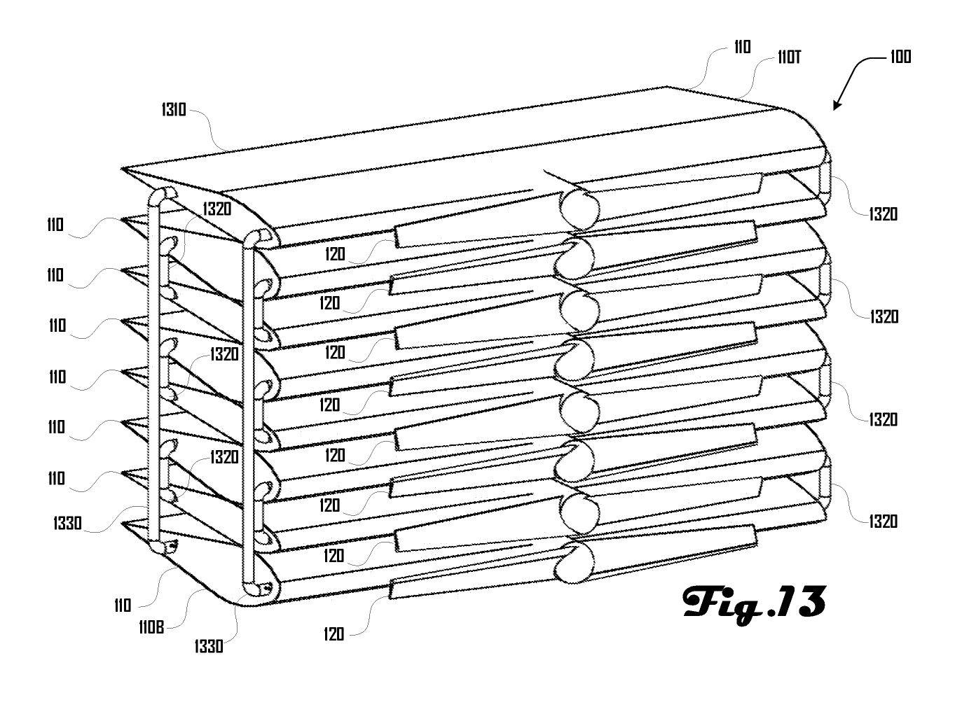

FIG. 12a shows an example embodiment of a tethered wing 100 comprising a polygon of straight wing sections. FIG. 12b shows an example embodiment of a polygon tethered wing 100 where the span is greater than the height as per an ellipse. FIG. 13 shows an example embodiment of a polygon tethered wing 100 in a folded or packed configuration wherein sections 1310 of the wing body 110 have been disengaged from a ring configuration at respective joints and stacked. The sections 1310 remain connected via couplers 1320, which can facilitate and stabilize the stacked configurations, which can be desirable for compact transport or storage of the tethered wing 100. A pair of spanning couplers 1330 are illustrated coupling a top and bottom portion 100T, 100B of the stacked sections 1310.

Although this example is illustrated in relation to a polygon wing body 110 having a plurality of straight wing section 1310 of equal length, stacking and/or folding of a wing body 110 can be implemented for any suitable shape of wing body 110, including ring and non-ring embodiments. In other words, various embodiments of a wing body 110 can be configured for disassembly into a plurality of portions 1310. Such portions 1310 can remain coupled via couplers 1320 (or other suitable structure), or such portions 1310 can be completely separated.

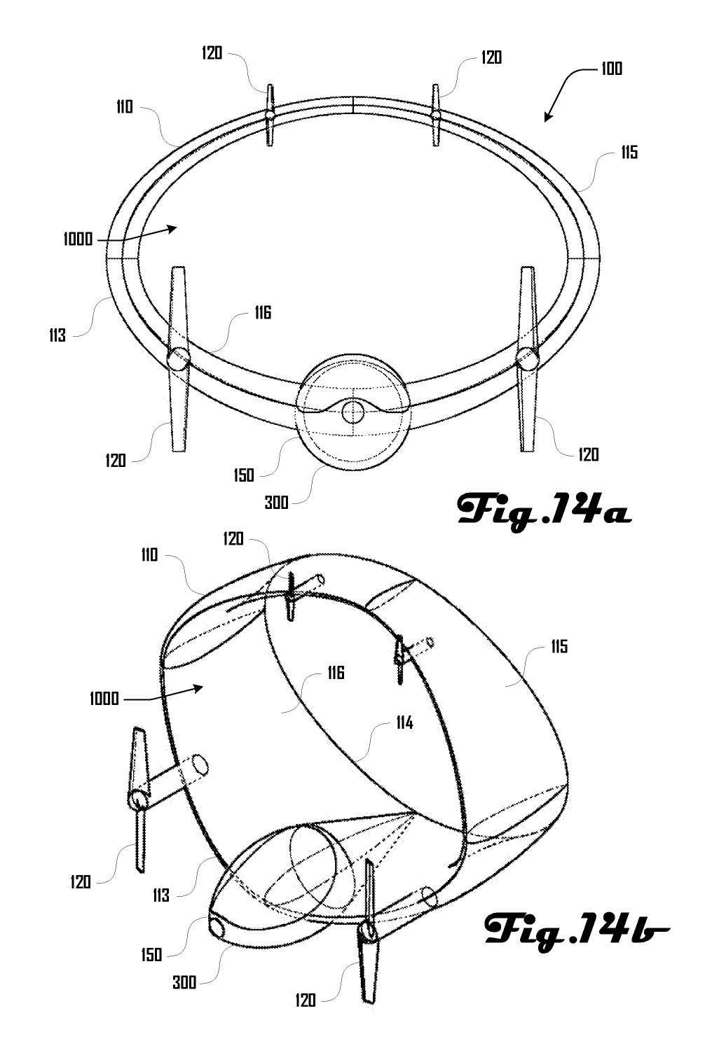

FIGS. 14a and 14b show an example embodiment of an elliptical ring-wing body 110 with differently sized and positioned rotors 120. An integrated fuselage 300 is also shown, which in some embodiments can rotate around the axis of the span of the wing body 110 so as to maintain a horizontal position in both vertical and horizontal flight modes.

FIGS. 21a and 21b show an example embodiment of a tethered wing 100 comprising a bean shaped wing body 110, which can comprise an elliptical or oval-shaped top portion 2110, with an inverted bottom portion 2120. In other words, the top portion 2110 defines a concave portion of the wing orifice 1000 and the bottom portion 2120 defines a convex portion of the wing orifice 1000. In some embodiments, the bottom portion 2120 can be flat or linear instead of being concave as illustrated in FIGS. 21a and 21b.

Accordingly, as discussed above, embodiments of a tethered wing 100 can comprise an annulus or ring which has an airfoil section. Batteries, control electronics, payload 150, speed controllers, and so forth, can be embedded into the ring-wing so as to avoid additional drag. This can result in an aerodynamically clean aircraft that has little drag along the primary axis of thrust. Alternatively, various embodiments can be described as a constant chord airfoil section curved into a ring or annulus with a plurality of rotors 120 mounted around its circumference.

In some examples, a tethered wing 100 can take off and land vertically, as a tail-sitter, before transitioning to forward flight. In vertical flight mode, control can be achieved with selective speed control of different propellers so as to achieve direct control of pitch, roll, yaw, and vertical speed. In some embodiments, rotors 120 can further be oriented slightly off axis so as to better facilitate yaw control, or orthogonally to directly control other axes, and so forth. With speed control, active propeller pitch control or active aerodynamic control surfaces may not be required in some embodiments and can be absent in various embodiment. However such structures can be present in further embodiments. In horizontal flight mode, selective speed control can be used to directly control pitch, yaw, roll, and forward speed. Some embodiments can use differential thrust to control pitch which can remove the need for a tail plane or a flying wing airfoil profile.

In various examples, a ring-wing body 110 can include additional stabilization structures such as fins, wings, flaps, a tail, or the like, or any of such elements can be absent. For example, as illustrated in FIGS. 10a, 10b, 11a, 11b, 12a, 12b, and the like. A ring wing tethered wing 100 can include a wing body 110 that defines a contiguous aerodynamic streamlined shell with such additional body elements being substantially absent.

Additionally, as discussed herein, any suitable number of rotors 120 can be associated with a ring-wing body 110. Such rotors 120 can be the same size or different sized and can be spaced or disposed in any suitable way or arrangement around the ring-wing body 110.

Additionally, in some embodiments a payload 150 or payload carrier can be incorporated into a portion of a ring wing body 110. For example, FIGS. 14a and 14b illustrate a payload 150 of a passenger cabin 300 being disposed within a portion of the ring-wing body 110.

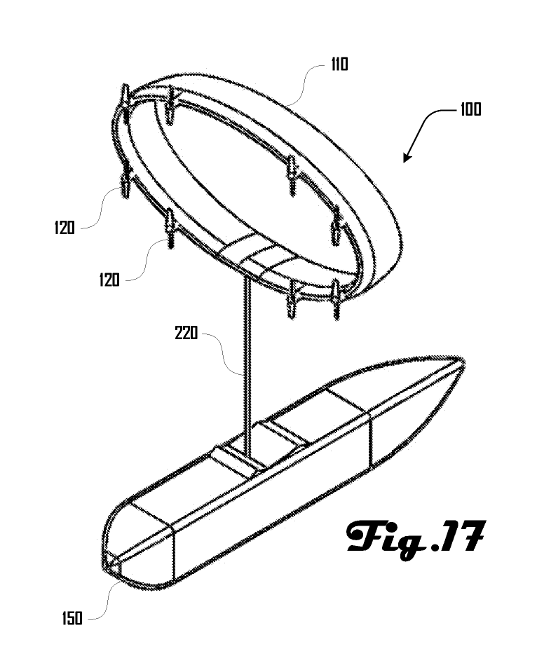

In further embodiments, a payload 150 can be tethered to a ring wing body 110 in various suitable ways. For example, FIGS. 15a and 15b, illustrate one example of a tether 220 coupled to a portion of a ring wing body 110. FIG. 17 illustrates another example embodiment of a tether 220 coupled to a portion of a ring wing body 110 and payload 150. In some embodiments, rotors 120 can be incorporated in counter rotating pairs so as to enable yaw control in the vertical flight mode, or roll control in the horizontal flight mode. Differential thrust, (e.g., by electric motor speed control), can be used to control pitch and roll in the vertical flight mode, and pitch and yaw in the horizontal flight mode. Collective thrust can be used to control vertical speed in the vertical flight mode and horizontal speed in the horizontal flight mode. Such embodiments of a tethered wing 100, that can generate lift from the wing body 110, can be fundamentally capable of significantly higher range and endurance than conventional aerial vehicles while still having vertical takeoff and landing capability.

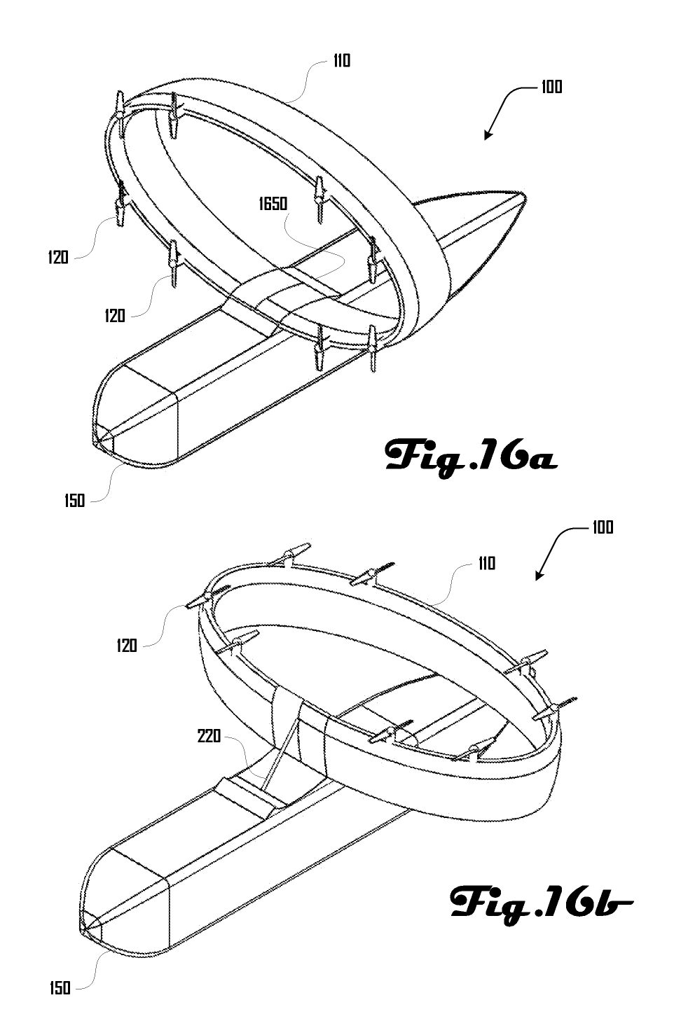

Additionally, a ring wing body 110 can be configured to assume a vertical flight configuration and a horizontal flight configuration as discussed above (e.g., in relation to FIGS. 5 and 6). In further embodiments, transitioning between horizontal and vertical flight configurations can include structures associated with a payload 150 or other suitable structure. For example, FIG. 16a illustrates a tethered wing 100 having a ring wing body 110 in a horizontal flight configuration relative to a payload 150, wherein the ring wing body 110 is coupled directly to the payload 150. FIG. 16b illustrates the tethered wing 100 of FIG. 16a wherein the ring wing body 110 is in a vertical flight configuration relative to a payload 150, wherein the ring wing body 110 is coupled directly to the payload 150 at a hinge 1650, which allows the ring wing body 110 to transition from the horizontal to vertical flight configuration and vice versa. Additionally, FIG. 17 illustrates the tethered wing 100 of FIGS. 16a and 16b with a tether 220 being in an extended configuration.

Although various embodiments discussed herein relate to a tethered wing 100 configured to transport a payload 150, in some embodiments, a tethered wing 100 can be tethered in place and may or may not lift a payload 150. For example, FIG. 15b shows an example embodiment of a tethered wing 100 which is directly tethered to an anchor 1550 via a tether 220, wherein the tethered wing 100 circles above the payload 150, which in this example serves to anchor the tethered wing 100 to the ground. In some embodiments, the payload 150 of FIG. 15b can comprise an anchor 1550 as illustrated in FIG. 15a.

FIG. 15a shows another embodiment of a tethered wing 100 coupled to a payload 150 via a tether 220. An anchor line 1530 is coupled to the payload 150, which tethers the payload 150 to an anchor 1550, which anchors the payload 150 and tethered wing 100. As illustrated in this example, the tethered wing 100 can rotate about the payload 150 and/or anchor 1550 to lift the payload 150.

Accordingly, embodiments of a tethered wing 100 can be used to lift a payload 150 via a tether 220 with the payload being tethered to the ground or other location at an anchor 1550. In so doing, it can be used as an aerostat in some embodiments. Electricity or other fuel can be transmitted up the one or more tethers 220, 1530 to the tethered wing 100 in further embodiments so as to enable the tethered wing 100, (and in some embodiments the desired payload 150), to remain continuously aloft. Such embodiments can further use wind to help keep the tethered wing 100 aloft and reduce the power required to be transmitted up from the ground, even generating net power in some wind conditions.

As illustrated in FIGS. 15a and 15b, in some embodiments a tethered wing 100 can act as an aerostat system 1500 which may or may not support a payload 150 at altitude in a continuous fashion. Applications for such embodiments include communications (flying antennas), monitoring, sky cranes, and so forth. In an embodiment, tethered wing 100 takes off vertically before circling and lifting the main payload 150 which is itself tethered to the ground. Power, (e.g., via electricity or fuel) can be transmitted up the tether(s) 220, 1550 so as to enable continuous operation. In various embodiments, a tethered wing 100 can utilize wind to stay aloft and/or generate power. For example, in strong winds the tethered wing 100 can cease active forward flight with respect to the ground, point directly into the wind, and reduce ring-wing angle of incidence so as to reduce lift and strain upon the tether(s) 220, 1550. Being able to generate power from the wind from relatively low wind speeds can also greatly reduce the required external power required. A plurality of tethered wings 100 can be used in various embodiments to lift a given payload 150, which can provide redundancy and reduce payload oscillation. Other systems to reduce payload oscillation can also be employed in further embodiments, including thrusters on the payload 150, additional dynamic balancing masses, and so forth.

In still further embodiments, a tethered ring-wing multicopter can be attached to a ground station and used to generate power from the wind. For example, rotors 120 and motors can be operated in reverse, generating electricity which can be transmitted down the tether(s) 220, 1550. In some embodiments, when there is sufficient wind for net power generation, the tethered wing 100 can launch itself and then fly crosswind against the tether(s) 220, 1550 so as to generate power. When there is insufficient wind for power generation, the tethered wing 100 can motor to stay aloft, or can land to wait for wind.

In other words, a system 1500 comprising a grounded tethered wing 100 can determine whether wind conditions are sufficient for net power generation via the system 1500, and if so, the tethered wing 100 can launch and generate power. The system 1500 can continue to determine whether wind conditions are sufficient for net power generation and for maintaining altitude, and if so, the tethered wing 100 can stay airborne to generate power. However, if wind conditions are not sufficient for net power generation and/or if wind conditions are not sufficient for maintaining altitude, the tethered wing 100 can land or can activate rotors 120 to maintain altitude. Such actions can occur automatically, without human interaction in some embodiments.

In further embodiments, a tethered wing 100 can be used for transportation and to generate power from wind when not being used for transportation. For example, where a tethered wing 100 is waiting at a pickup location, destination, charging station, payload swapping location or the like, the tethered wing 100 can launch and generate power as discussed herein. This can further reduce the effective cost of the tethered wing 100, enable self-recharging of battery systems, and so forth. For example, one embodiment of a tethered wing 100 used for transport purposes can land and anchor itself and generate power from the wind so as to recharge its batteries or supply power to an electricity grid. Accordingly, in some embodiments, transport and recharging can occur automatically without human interaction.

In some embodiments, an anchored tethered wing 100 can be flown a high altitudes and be configured to provide communications, surveillance services, reconnaissance, weather observations, ground imaging, high altitude science missions, and the like. In various embodiments, power can be transmitted up and down tether(s) 220, 1550, enabling it to generate power when the wind blows, and to be powered when it does not, also powering onboard equipment. In some embodiments, adding an electrolysis unit for regenerating the liquid hydrogen from water collected from the exhaust can provide a pathway to continuous operation.

Various embodiments of a tethered wing 100 can be configured for solar powered operation, which in some examples can be in part due to a large lateral wing body area that can better intersect sunlight when the sun is low in the sky. Indeed, various embodiments of the tethered wing 100 can be capable of single axis tracking by rolling to better point solar cells towards the sun. Skewing the top and bottom wing sections fore and aft so that the top wing does not shade the bottom wing and adopting flight path directions that maximize sunlight collection can further help increase available solar power in accordance with some embodiments. Solar powered tethered wings 100 can also use battery power, altitude gravitational potential energy storage, slow flying speeds and drifting with the wind, slope soaring, thermalling, and dynamic soaring to further increase endurance, range, and speed. In further embodiments, low altitude solar powered tethered wings 100 can land for some part of the night so as to conserve battery power before taking off again to fly the next day. In some embodiments, any of these actions can occur automatically without human interaction.

In some embodiments, a trailing edge of the wing body 100 can comprise landing struts that extend out. Such landing struts can be actively deployed. In some embodiments, landing struts can comprise wheels on the end to enable transport of the tethered wing 100 across a surface. Such landing wheels can be steerable, comprise shock absorbers and/or powered. In some embodiments, landing struts can be co-located with motor and propeller units. In some embodiments, the trailing edge of the wing body 110 can be scalloped between landing contact points. In some embodiments, the landing struts can be actuated to facilitate jump take off maneuvers. In some embodiments, the tethered wing 100 can land and/or takeoff from a frame.

In various embodiments, a tethered wing 100 can act as or comprise a wind turbine configured to generate electrical power. For example, in some embodiments, in addition to rotors 120 of a tethered wing 100 being configured to provide propulsion for the tethered wing 100, rotors 120 can also be configured to act as a wind turbine configured to generate electrical power as described herein. In further embodiments, a tethered wing 100 can comprise wind turbines that are separate from rotors 120. In such embodiments, rotors 120 and/or wind turbines of a tethered wing 100 can be configured to generate power while the tethered wing 100 is exposed to wind. For example, the tethered wing 100 can generate power while flying or can be tethered in a fixed location such as being tethered to the ground, or the like.

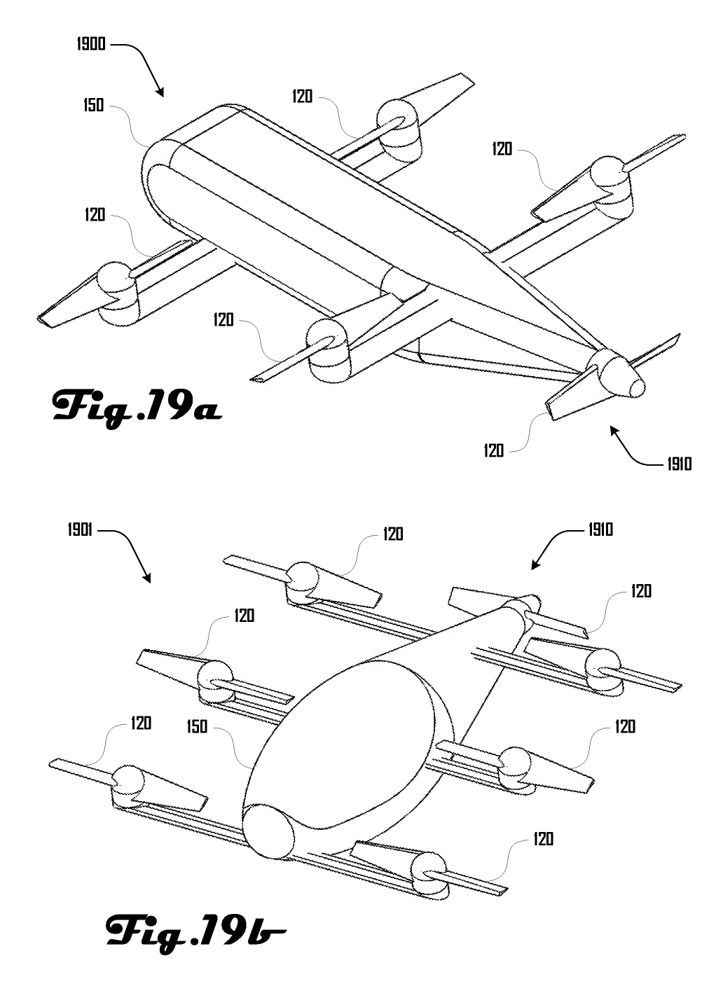

Although specific embodiments of a tethered wing 100 and wing body 110 are described herein, these examples should not be construed to be limiting on the wide variety of suitable alternative configurations and systems that can be implemented that are within the scope and spirit of the present invention. For example, FIGS. 19a and 19b illustrate examples of a quadcopter 1900 and hexcopter 1901 that can be used in various embodiments. As shown in these examples, the vehicle can comprise a set of primary rotors 120 and a tail rotor 1910.

In some embodiments, a tethered wing 100 or portion thereof can be employed as an electric rocket-like system, electric sounding rocket-like system, or the like. For example, in some embodiments, a tethered wing 100 can be configured to quickly fly to a high altitude (e.g., 20-30 km) and then glide down, using remaining battery power to maintain altitude, or the like. In other words, a tethered wing 100 can be configured to fly to high altitude from a base station, hover or loiter for a period of time, and return to the base station to recharge or refuel.

In some embodiments, a set of such rocket-like tethered wings 100 can be launched in successively in rotation for various suitable purposes including surveillance, atmospheric monitoring, acting as a communication station for a network (e.g., cell or internet service), or the like. For example, a first rocket-like tethered wing 100 can be launched to a desired elevation and position and loiter until the tethered wing 100 power supply is depleted. A second rocket-like tethered wing 100 can be launched to replace the first rocket-like tethered wing 100 such that a consistent presence can be maintained.

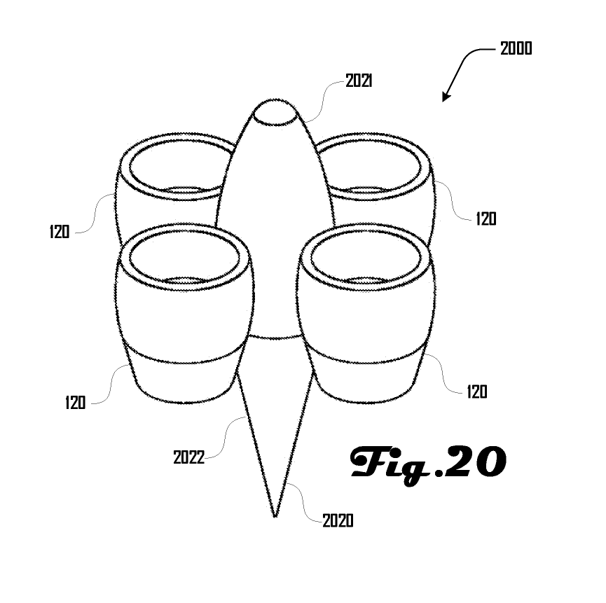

A rocket-like tethered wing 100 system can also be configured for operation as a mid-air refueling system. Refueling can be via chemical fuels, batteries, or the like as discussed herein. Rocket-like staging systems can be employed in further embodiments; for example, one electric rocket-like system can lift another to altitude, before automatically returning to a base station, leaving the second electric rocket-like system to loiter with a set of fully charged batteries. FIG. 20 illustrates an alternative embodiment of a system 2000 that can be used as a rocket-like system as discussed above. This example system 2000 includes a plurality of rotors 120 arranged around an aerodynamic body 2020, which comprises a nose cone 2021 and a tail 2022.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A flying truck system comprising:
a first tethered wing comprising:
an aerodynamic wing body defining external and internal faces and front and rear edges;
a plurality of rotors disposed on the front edge; and
a tether configured to extend and retract,
wherein the first tethered wing is configured to perform a payload pickup maneuver that includes:
coupling the tether to a payload with the tether in an extended configuration;
taking off in a vertical flight configuration proximate to the tethered payload;
transitioning to a horizontal flight configuration over the tethered payload;
circling and ascending over the tethered payload to lift the tethered payload into the air via the tether; and
reeling in the tether into a retracted configuration;
wherein the first tethered wing is configured to fly to a payload drop zone in the horizontal flight configuration; and
wherein the first tethered wing is configured to perform a payload delivery maneuver that includes:
circling over the payload drop zone in the horizontal flight configuration;
reeling out the tether into the extended configuration;
circling and descending over the payload drop zone to drop the payload in the payload drop zone;
transitioning to a vertical flight configuration; and
descending in the vertical flight configuration to land proximate to the payload drop zone.

2. The flying truck system of claim 1, wherein the tethered wing is configured to perform the payload pickup maneuver and payload delivery maneuver automatically without human interaction.

3. The flying truck system of claim 1, wherein the ring body defines a ring wing that defines a ring orifice.

4. The flying truck system of claim 1, wherein the payload comprises at least one of an ISO standard shipping container or ISO standard air cargo container.

5. The flying truck system of claim 1 further comprising a second aerial vehicle, and
wherein the first tethered wing is further configured to:
meet with the second aerial vehicle while flying in the horizontal flight configuration and carrying a payload; and
transfer the payload to the second aerial vehicle, and
wherein the second aerial vehicle is configured to fly to a payload drop zone in a horizontal flight configuration and perform the payload delivery maneuver.

6. The flying truck system of claim 1, wherein the first tethered wing is further configured to dock with and charge at an aerial charging station while flying to a payload drop zone in the horizontal flight configuration.

7. A tethered wing comprising:
an aerodynamic wing body defining external and internal faces and front and rear edges;
a plurality of rotors disposed the wing body; and
a tether configured to extend and retract,
wherein the first tethered wing is configured to perform a payload pickup maneuver that includes:
coupling the tether to a payload with the tether in an extended configuration;
taking off in a vertical flight configuration proximate to the tethered payload;
transitioning to a horizontal flight configuration over the tethered payload;
circling and ascending over the tethered payload to lift the tethered payload into the air via the tether; and
reeling in the tether into a retracted configuration.

8. The tethered wing of claim 7, wherein the wing body defines a ring wing that defines a ring orifice.

9. The tethered wing of claim 7, wherein the ring body defines polygon ring wing defined by a plurality of straight wing sections and wherein the straight wing sections are configured to be disengaged from each other at respective joints and wherein the straight wing sections are configured to be folded in a stacked configuration.

10. The tethered wing of claim 7, wherein the payload comprises an active thrust stabilizing system configured to control the position and orientation of the payload.

11. The tethered wing of claim 7 further configured to carry at least one human passenger.

12. The tethered wing of claim 7 further configured to carry at least one of an ISO standard shipping container or ISO standard air cargo container.

13. The tethered wing of claim 7 further comprising solar cells defining a surface portion of the wing body.

14. The tethered wing of claim 7, wherein at least one of fins, wings, flaps, or a tail is absent from the wing body.

15. The tethered wing of claim 7, wherein the rotors are disposed in a static configuration on the wing body

16. A method of handling a payload with a tethered wing comprising a payload pickup maneuver that includes:
coupling a tether to a payload with the tether in an extended configuration;
taking off with the tethered wing in a vertical flight configuration proximate to the tethered payload;
transitioning the tethered wing to a horizontal flight configuration over the tethered payload; and
circling and ascending by the tethered wing over the tethered payload to lift the tethered payload into the air via the tether.

17. The method of claim 16, wherein the payload pickup maneuver is performed automatically without human interaction.

18. The method of claim 16 further comprising a payload drop-off maneuver that includes:
circling the tethered wing over a payload drop zone in the horizontal flight configuration;
circling and descending the tethered wing over the payload drop zone to drop the payload in the payload drop zone;
transitioning the tethered wing to a vertical flight configuration; and
descending the tethered wing in the vertical flight configuration to land proximate to the payload drop zone.

19. The method of claim 18, wherein the payload pickup maneuver is performed automatically without human interaction.
